(19) United States
(12) Patent Application Publication
(10) Pub. No.: US 2007/0279335 A1
(43) Pub. Date: Dec. 6, 2007

(54) SIGNAL LEVEL ADJUSTING APPARATUS

(75) Inventors: Chiu-Yuan Lin, Taipei City (TW); Shih-Chung Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/461,412

(22) Filed: Jul. 31, 2006

(30) Foreign Application Priority Data
Jun. 2, 2006 (TW) 95119534

(51) Int. Cl. G09G 3/30

(52) U.S. Cl. 345/76

(57) ABSTRACT

A signal level adjusting apparatus is provided. The signal level adjusting apparatus uses a clamping circuit as an automatic level adjusting apparatus to adjust a signal level. Then, a peak or a valley voltage of a driving signal output from the signal level adjusting apparatus can be confined in a predetermined voltage value range. The present invention adjusts an input driving signal automatically according to the predetermined voltage value so as to output an organic light emitting diode (OLED) driving signal suitable for driving various OLEDs and various OLED displays or output a light emitting diode (LED) driving signal suitable for driving various LEDs. Additionally, the present invention further comprises a power amplifier circuit, which is suitable for enhancing a driving ability of the level adjusting apparatus.

### CROSS-REFERENCE TO RELATED APPLICATION

This application claims the priority benefit of Taiwan application serial no. 95119534, filed Jun. 2, 2006. All disclosure of the Taiwan application is incorporated herein by reference.

### BACKGROUND OF THE INVENTION

1. Field of Invention

The present invention relates to a signal level adjusting apparatus. More particularly, the present invention relates to a signal level adjusting apparatus with a clamping function.

2. Description of Related Art

Organic light emitting diodes (OLED), made of organic compounds, are used in organic light emitting displays (OLED display) for displaying images. Due to the advantages of OLEDs such as strong contrast, high luminance, wide view angle, high speed, low power consumption, being light, thin, short, and small, and flexibility, it is expected that OLED displays will play an important role in image displays. The OLED displays adopt a self-light emitting technology, and the display technology thereof is apparently different from conventional LCDs, in which backlight sources are not required. As shown in FIG. 1, when the OLED display is used for displaying images, a video signal, such as a composite video broadcast signal (CVBS) and an S-Video in different signal formats, is received on the control panel of the display. Then, a video signal decoder 100 is used to decode the data content of the video signal to obtain an input signal Vrgb (101). A manual signal level adjusting apparatus 102 receives the input signal Vrgb, and adjusts the image content and color to be displayed to an optimal state, thus outputting an output signal Vrgb′ (103) to an OLED display 104.

As shown in FIG. 2, the level shift circuit of the conventional manual signal level adjusting apparatus is mainly used to adjust the level of signal (i.e. the input signal Vrgb) decoded and output by the video signal decoder 100. The input signal Vrgb passes through a capacitor 202 in which a DC component of the input signal Vrgb is filtered. Then, the voltage of the input signal Vrgb is leveled up by variable resistor 204 and resistor 206 connected in series, so as to improve the mean value of the signal, thereby obtaining the output signal Vrgb′. In this manner, the effect of controlling the color intensity can be achieved, thus enhancing the effect of the output image of the OLED display.

FIGS. 3(a)-(d) are schematic views of the signal level of the above-mentioned manual signal level adjusting apparatus. As shown in FIG. 3(a), the input signal Vrgb of a high peak-to-peak value passes through the level shift circuit of the manual signal level adjusting apparatus of FIG. 2. After the variable resistor 204 is adjusted by the user to generate a voltage division, the input signal Vrgb of the high peak-to-peak value is adjusted to the suitable voltage level that has a mean value of the division voltage to be output as shown in FIG. 3(b), such that the OLED display generates a preferred color effect. In the same operation circuit, as shown in FIG. 3(c), after the input signal Vrgb of a relatively low peak-to-peak value is adjusted in the manner described above, the voltage level as shown in FIG. 3(d) is output. However, as for an OLED display, the initial level of the DC valley value VL (or peak value VH) of the required three primary-color signal (i.e. the above-mentioned output signal Vrgb′, indicating the voltage amplitude of the three primary-color of Red/Green/Blue) must be the same. Therefore, the manual signal level adjusting apparatus suitable for the signal as shown in FIG. 3(a) must be manually adjusted when the source signal is changed into the different signal as shown in FIG. 3(c), so as to obtain a preferable color effect of the OLED display. Thus, although the circuit structure of the conventional manual signal level adjusting apparatus is simple, the level adjustment value of the conventional manual signal level adjusting apparatus used to adjust the level of a different signal must be manually adjusted.

Furthermore, the manual signal level adjusting apparatus uses a variable resistor to adjust the level adjustment value thereof. However, due to the significant error tolerance of the specification of the variable resistor, the level adjustment value of each manual signal level adjusting apparatus must be manually adjusted. Therefore, it is inconvenient in fabricating and using the conventional manual signal level adjusting apparatus in practice. Moreover, due to the limited driving ability, the manual signal level adjusting apparatus does not have a performance in high-power operation. Therefore, the manual signal level adjusting apparatus can only be used in the specific OLED displays, and is not applicable to the common OLED displays.

### SUMMARY OF THE INVENTION

Accordingly, the present invention is directed to use a clamping circuit as an automatic level adjusting apparatus to adjust an image signal of the OLED display, such that the peak value or valley value of the input signal of the image can be stabilized in a predetermined voltage value. The design of the present invention involves automatically adjusting the input image signal of the OLED display according to a predetermined voltage value, so as to make the peak value or valley value of the OLED display be the same as the predetermined voltage value, such that the automatic level adjustment can be achieved and the design of present invention can be used in the OLED displays with various input signal levels and even panels of different dimensions.

Furthermore, error tolerances of the elements used in the clamping circuit of the present invention are small, such that the level adjustment value in consistency can be provided, and the problem of manually adjusting each of the signal level adjusting apparatuses in the conventional art can be avoided.

Additionally, the present invention further comprises a power amplifier circuit for increasing the power supply of the signal level adjusting apparatus and thus enhancing the clamping ability, such that the signal level adjusting apparatus can be applicable to the OLED display having high power consumption.

Herein, the present invention provides a signal level adjusting apparatus for adjusting the level of the output signal. The signal level adjusting apparatus comprises a reference voltage source and a clamping unit. The reference voltage source provides a reference voltage signal. The clamping unit converts the input signal into the output signal according to the reference voltage signal, in which the valley levels of the output signals are substantially the same.

The present invention also provides another signal level adjusting apparatus for adjusting the level of the input signal. The signal level adjusting apparatus comprises a reference voltage source and a clamping unit. The reference voltage source provides a reference voltage signal. The clamping unit converts the input signal into the output signal according to the reference voltage signal, in which the levels of the peak levels of the output signals are substantially the same.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a block diagram of a video processing device in the conventional art.

FIG. 2 is a circuit diagram of a manual signal level adjusting apparatus in the conventional art.

FIGS. 3(a) to (d) are schematic views of the signal level adjustment using the manual signal level adjusting apparatus in the conventional art.

FIG. 4 is a view of a signal level adjusting apparatus according to a preferred embodiment of the present invention.

FIG. 5 is a block diagram of a video processing device of the present invention.

FIG. 6(a) to (d) are schematic views of the signal level adjustment using the signal level adjusting apparatus of the present invention.

FIG. 7 is a view of a signal level adjusting apparatus according to another preferred embodiment of the present invention.

FIG. 8 is a view of a signal level adjusting apparatus according to still another preferred embodiment of the present invention.

FIGS. 9, 10, and 11 are views of the signal level adjusting apparatus with the valley clamping circuit as shown in FIGS. 4, 7, and 8 adjusted to be the peak clamping circuit.

FIG. 12(a) to (d) are schematic views of the signal level adjustment using the signal level adjusting apparatus of FIGS. 9, 10, and 11.

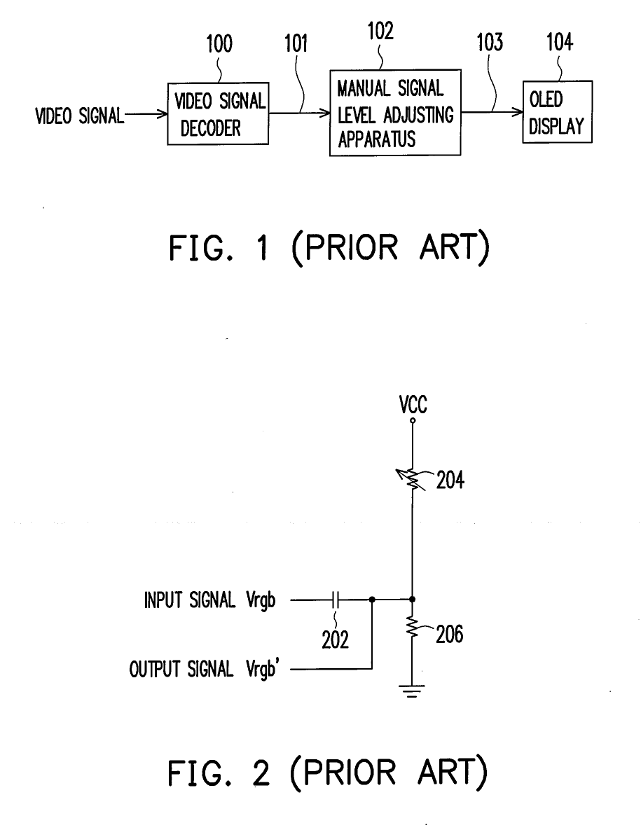

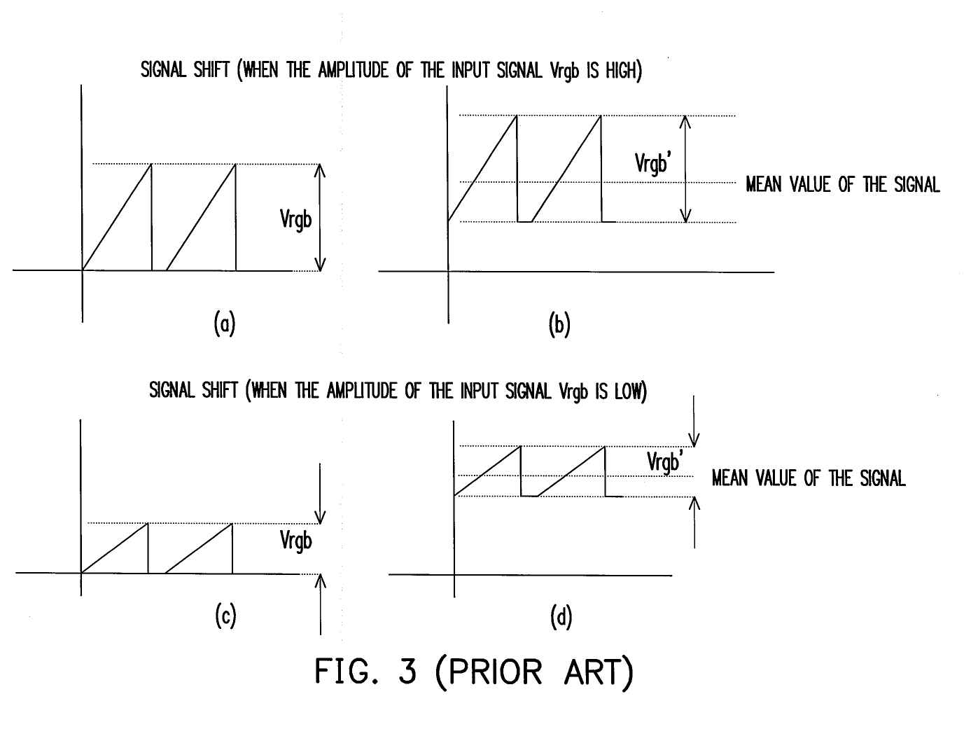

### DESCRIPTION OF EMBODIMENTS

The essence of the present invention is to use a clamping circuit to shift the level of the input signal with any amplitude, such that the level of the valley or peak of the signal is shifted to the same predetermined level. Thus, regardless the changes of the amplitude of the signal, the valley or peak of the output signal can be adjusted to the same level through the level shift of the clamping circuit of the present invention, thereby satisfying the requirement of driving signal of the OLED display. Definitely, the signal level adjusting apparatus of the present invention can be used to drive an organic light emitting diode, a light emitting diode, an OLED display, a LED display, or other elements using or having the same driving requirement.

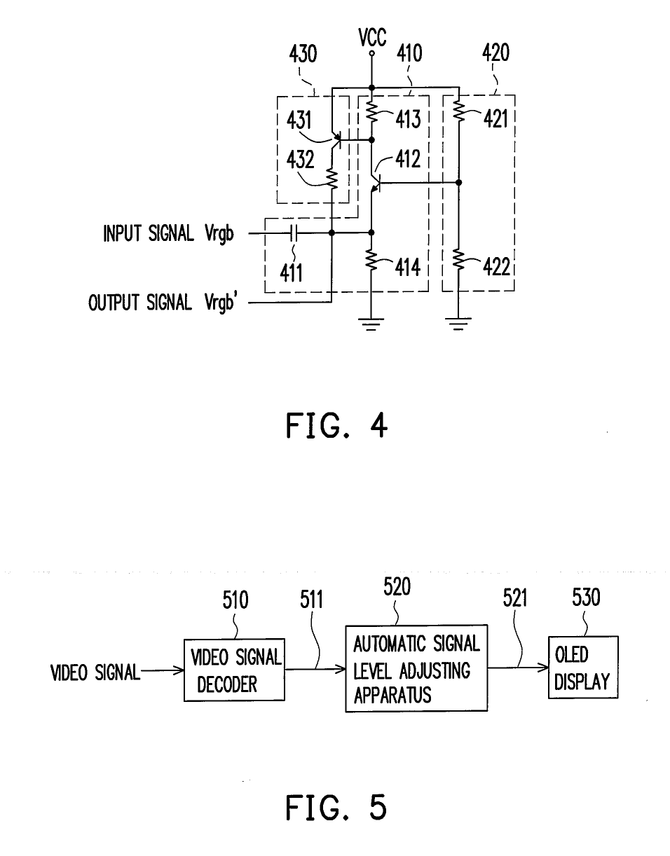

FIG. 4 is a signal level adjusting apparatus according to a preferred embodiment of the present invention. The signal level adjusting apparatus comprises a clamping circuit 410, a reference voltage source 420, and a power amplifier circuit 430. A capacitor 411 in the clamping circuit 410 filters out the DC component in the input signal Vrgb and then input the filtered input signal Vrgb to a clamping unit. The clamping unit comprises a bipolar junction transistor (BJT) 412, and resistors 413, 414. The reference voltage source 420 comprises resistors 421, 422. One end of the resistors 413, 421 is connected to the voltage source VCC. One end of the resistors 414, 422 is grounded. The BJT 412 has a base connected to the other end of the resistors 421, 422, a collector connected to the other end of the resistor 413, and an emitter connected to the other end of the resistor 414. The voltage of the base of the BJT 412 is determined by the division voltage of the resistors 421, 422, and the potential of the emitter of the BJT 412, due to the characteristic of the BJT 412, is lower than that of the base by about a forward bias of the PN junction. Thus, the potential of the emitter of the BJT 412 is clamped to an approximately fixed level, i.e. the division voltage of the resistors 421, 422 minus the potential difference between the base and the emitter of the BJT 412.

Accordingly, the clamping circuit 410 can raise the level of the filtered input signal to a predetermined value and then output it, such that the valley value of the output Vrgb′ is approximately equal to a predetermined value and then is output to the OLED display. The output signal Vrgb′ becomes the signal required by the OLED display. In other words, without regard to the value and range of the amplitude of the input signal Vrgb, after the signal is converted by the signal level adjusting apparatus, the valley value of the signal is clamped and then shifted to a predetermined value. Additionally, the power amplifier circuit 430 comprises a BJT 431 and a resistor 432 and is used to enhance the driving ability of the signal level adjusting apparatus. The BJT 431 has an emitter connected to the voltage source VCC, a base connected to the collector of the BJT 412, and a collector copuled to the emitter of the BJT 412 through the resistor 432. If the clamping circuit 410 of the signal level adjusting apparatus has a satisfying driving ability, the power amplifier circuit 430 can be omitted.

It can be known from the above embodiment that without regard to the amplitude of input signal, the signal level adjusting apparatus of the present invention can automatically adjust the shift amount of the level, such that the level of the valley value of the output signal is substantially the same level. FIG. 5 is a block diagram of automatically adjusting the level of the amplitude of the signal by using the signal level adjusting apparatus of the present invention. The input signal Vrgb (511) is obtained by decoding the data content of the video signal (such as a CVBS, an S-Video) by a video signal decoder 510. Next, the input signal Vrgb (511) is automatically adjusted to an optimal state by an automatic signal level adjusting apparatus 520 (i.e. the signal level adjusting apparatus of the present invention), and then the output signal Vrgb′ (521) is thus formed and input to the OLED display 530 for displaying preferred image content and color.

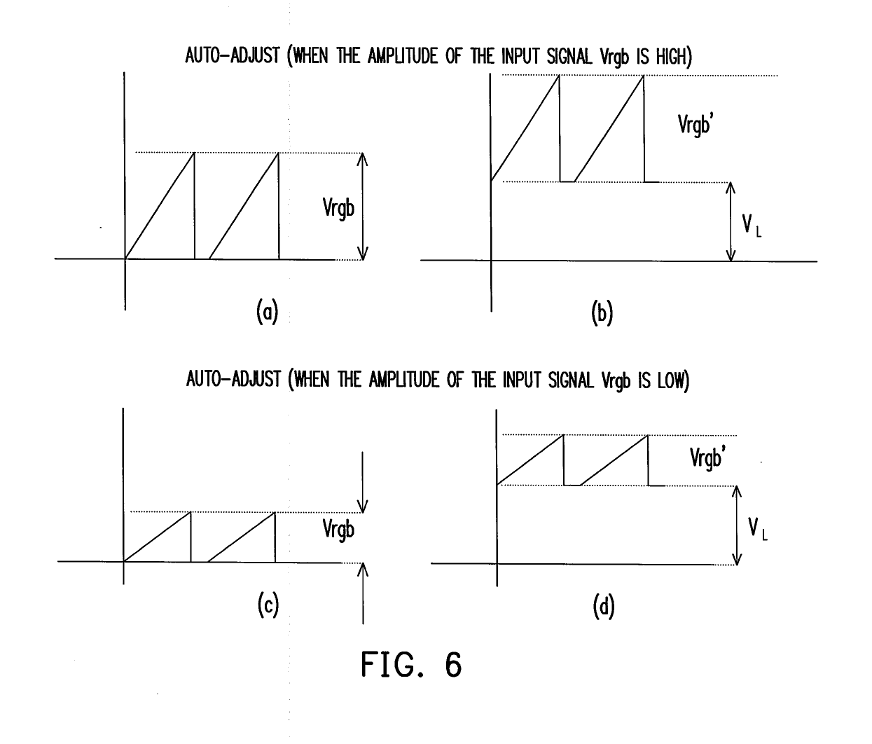

Then, referring to FIGS. 6(a) to (d), the level adjustment of the signal level adjusting apparatus of the present invention is illustrated. If the amplitude of the input signal Vrgb is relatively large as shown in FIG. 6(a), the level of the output signal Vrgb′ after going through a level adjustment using the signal level adjusting apparatus is shown in FIG. 6(b). If the amplitude of the input signal Vrgb is relatively small as shown in FIG. 6(c), the output signal Vrgb′ after being adjusted is shown in FIG. 6(d). After comparing the output signals Vrgb′ as shown in FIG. 6(b) and FIG. 6(d), it can be seen that the level of the valley value of the signal is automatically adjusted to V_{L}.

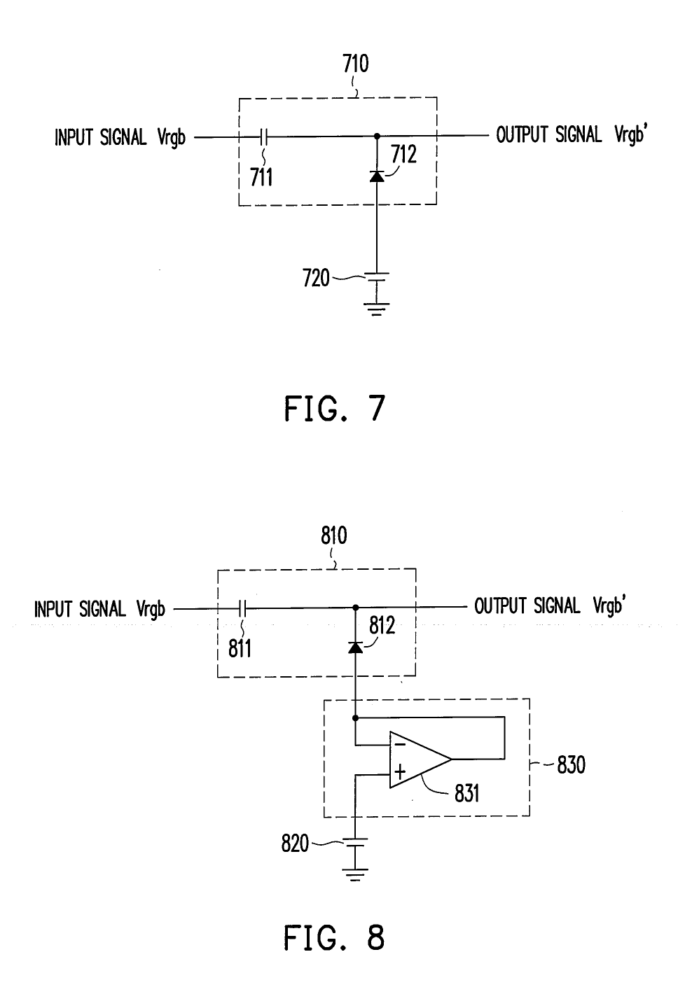

FIG. 7 is a signal level adjusting apparatus according to another preferred embodiment of the present invention. The signal level adjusting apparatus comprises a clamping circuit 710 and a reference voltage source 720. A capacitor 711 in the clamping circuit 710 filters out the DC component in the input signal Vrgb and then outputs the filtered input signal Vrgb to a clamping unit 712. The clamping unit 712 is a diode having an anode connected to the positive pole of the reference voltage source 720. The negative pole of the reference voltage source 720 is grounded. Therefore, the valley level of the output signal Vrgb′ is clamped by the clamping unit 712 to a substantially same level and then is output according to the reference voltage signal of the reference voltage source 720.

FIG. 8 is the signal level adjusting apparatus according to still another preferred embodiment of the present invention. The signal level adjusting apparatus comprises a clamping circuit 810, a reference voltage source 820, and a power amplifier circuit 830. The clamping circuit 810 comprises a capacitor 811 and a diode 812. The power amplifier circuit 830 comprises an amplifier 831. The reference voltage source 820 is coupled to the non-invert terminal of the amplifier 831, and the output terminal and the invert terminal of the amplifier 831 are connected to the anode of the diode 812, such that a voltage follower is formed. Compared with FIG. 7, a voltage follower is added to the circuit of FIG. 8 for enhancing the driving ability of the signal level adjusting apparatus and reducing the output current of the reference voltage source 820.

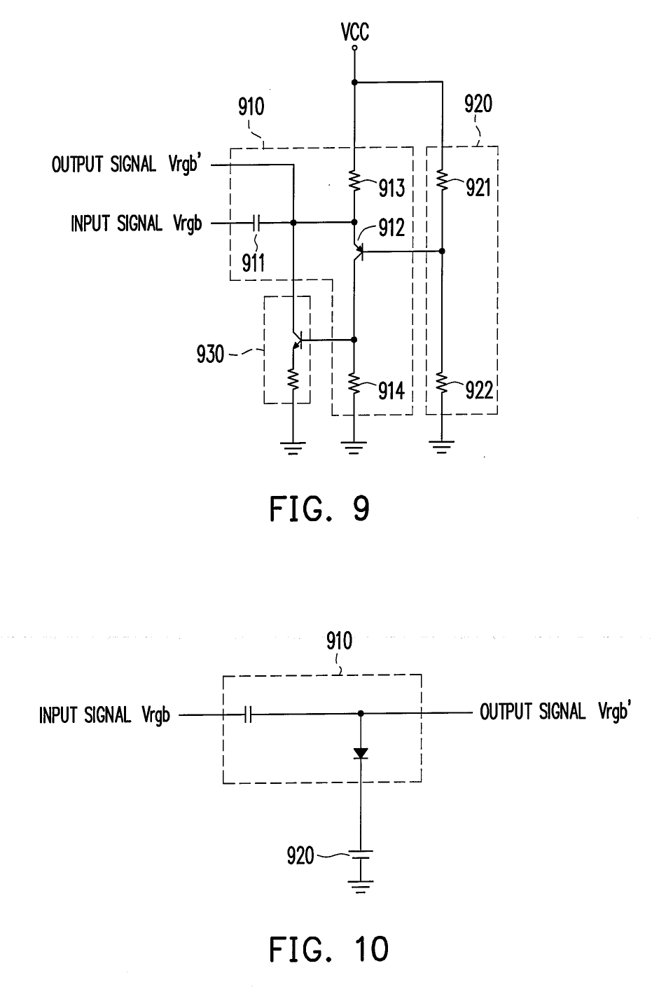

FIGS. 9, 10, and 11 are circuit diagrams obtained by respectively modifying FIGS. 4, 7, and 8, such that the peak values of the output signal Vrgb′ are substantially the same. The signal level adjusting apparatus as shown in FIG. 9 comprises a clamping circuit 910, a reference voltage source 920, and a power amplifier circuit 930. The clamping circuit 910 comprises a capacitor 911, a BJT 912, and resistors 913, 914. The reference voltage source 920 comprises resistors 921, 922. One end of the resistors 913, 921 is connected to the voltage source VCC. One end of the resistors 922, 914 is grounded. The BJT 912 has a base connected to the other end of the resistors 921, 922, a collector connected to the other end of the resistor 914, and an emitter connected to the other end of the resistor 913. The potential of the base of the BJT 912 is determined by the division voltage of the resistors 921, 922. The capacitor 911 of the clamping circuit 910 is used to filter out the DC component in the input signal Vrgb, and then the BJT 912 (i.e. the clamping unit) clamps the level of the peak level of the output signal Vrgb′ to a predetermined value according to the reference voltage signal of the reference voltage source 920. The power amplifier circuit 930 is used to enhance the driving ability of the signal level adjusting apparatus. One end of the power amplifier circuit 930 is grounded, and the other end of the power amplifier circuit 930 is coupled to the emitter of the BJT 912 for amplifying the power of the output signal Vrgb′. The power amplifier circuit 930, when the driving ability of the signal level apparatus is sufficient, can be omitted.

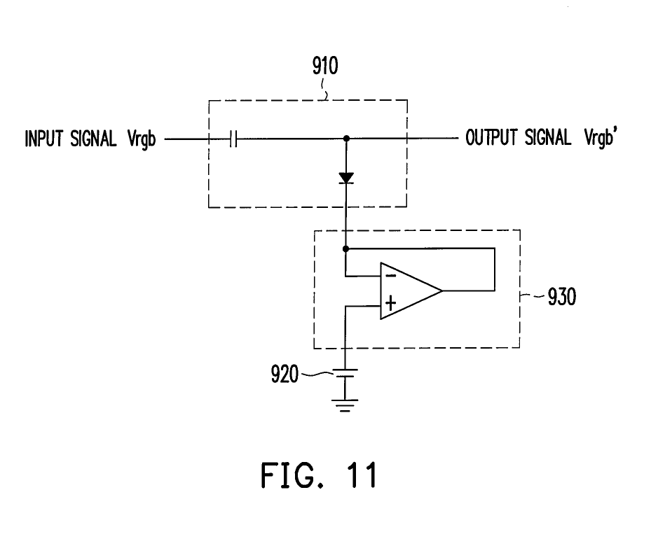

The signal level adjusting apparatus as shown in FIG. 10 comprises the clamping circuit 910 and the reference voltage source 920. The capacitor in the clamping circuit 910 filters out the DC component in the input signal Vrgb and outputs the filtered input signal Vrgb to the clamping unit (i.e. the diode). The clamping unit clamps the peak level of the output signal Vrgb′ to a substantially same level and then outputs it according to the reference voltage signal of the reference voltage source 920. Compared with FIG. 10, the power amplifier circuit 930 is added in FIG. 11. The power amplifier circuit 930 comprises an amplifier to form the voltage follower so as to enhance the driving ability of the signal level adjusting apparatus and reduce the output current of the reference voltage source 920.

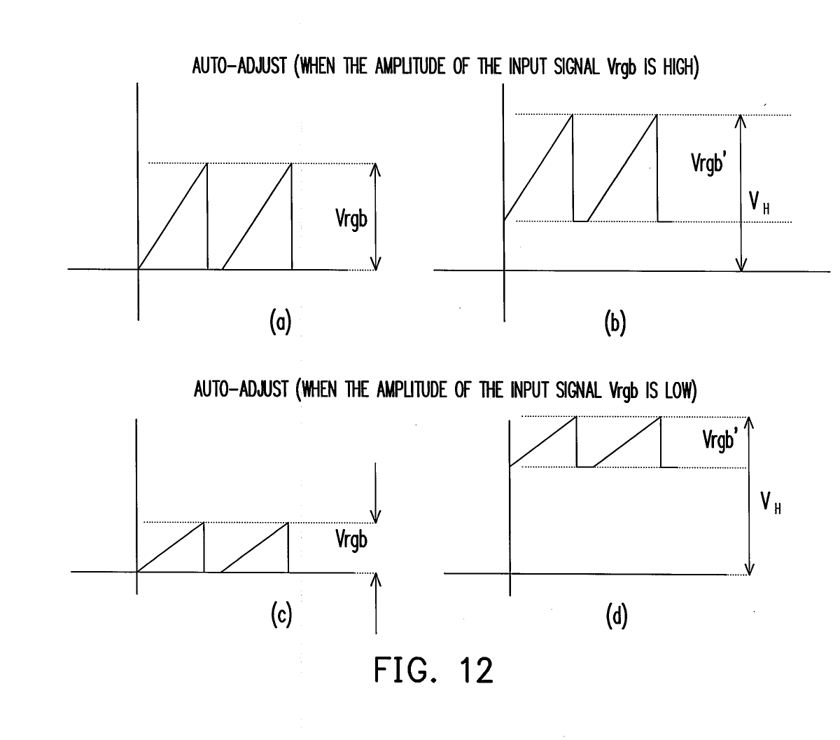

The level adjustment of the signal level adjusting apparatus, as shown in FIGS. 9, 10, and 11, is as shown in FIGS. 12(a) to (d). If the amplitude of the input signal Vrgb is relatively large as shown in FIG. 12(a), the level of the output signal Vrgb′ after going through a level adjustment using the signal level adjusting apparatus is shown in FIG. 12(b). If the amplitude of the input signal Vrgb is relatively small as shown in FIG. 12(c), the output signal Vrgb′ after being adjusted is shown in FIG. 12(d). After comparing the output signals Vrgb′ as shown in FIG. 12(b) and FIG. 12(d), it can be seen that the peak values of the signal can be automatically adjusted to V_{H}.

Since the elements having significant error tolerance such as variable resistors are not used in the signal level adjusting apparatus of the present invention, the level adjustment values between the signal level adjusting apparatuses are consistent, such that the trouble of manually adjusting each of the signal level adjusting apparatuses in the conventional art can be avoided.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A signal level adjusting apparatus, suitable for adjusting the levels of input signals, comprising:
a reference voltage source, for providing a reference voltage signal; and
a clamping unit, for converting the input signals into output signals according to the reference voltage signal, the valley levels of the output signals being substantially the same.

2. The signal level adjusting apparatus as claimed in claim 1, further comprising a light emitting element, wherein the clamping emit is coupled to drive the light emitting element and the light emitting element is an organic light emitting display (OLED display), a light emitting diode display (LED display), an organic light emitting diode (OLED), or a light emitting diode (LED).

3. The signal level adjusting apparatus as claimed in claim 1, wherein the clamping unit comprises a clamping element coupled to the reference voltage source, and the valley levels of the output signals are determined according to the reference voltage signal.

4. The signal level adjusting apparatus as claimed in claim 3, wherein the clamping element is a transistor or a diode.

5. The signal level adjusting apparatus as claimed in claim 4, wherein the reference voltage source comprises two resistors coupled in series to a voltage source for providing a division voltage as the reference voltage signal.

6. The signal level adjusting apparatus as claimed in claim 5, wherein the transistor is a first bipolar junction transistor (BJT) having a base for receiving the reference voltage signal and an emitter for outputting the output signals.

7. The signal level adjusting apparatus as claimed in claim 6, further comprising a power amplifier circuit with one end coupled to the voltage source and the other end coupled to the emitter of the first BJT, for amplifying the power of the output signals.

8. The signal level adjusting apparatus as claimed in claim 7, wherein the power amplifier circuit comprises an impedance unit and a second BJT, the second BJT having an emitter coupled to the voltage source, a base coupled to the collector of the first BJT, and a collector coupled to the emitter of the first BJT through the impedance unit.

9. The signal level adjusting apparatus as claimed in claim 3, wherein the clamping unit further comprises a power amplifier unit for receiving the reference voltage signal, amplifying the power of the reference voltage signal and then outputting the amplified signal to the clamping element.

10. The signal level adjusting apparatus as claimed in claim 9, wherein the power amplifier unit is an amplifier having a positive end for receiving the reference voltage signal, and a negative end and an output end being coupled to the clamping element.

11. The signal level adjusting apparatus as claimed in claim 10, wherein the clamping element is a diode.

12. A signal level adjusting apparatus, suitable for adjusting the levels of input signals, comprising:
a reference voltage source, for providing a reference voltage signal; and
a clamping unit, for converting the input signals into output signals according to the reference voltage signal, the peak levels of the output signals being substantially the same.

13. The signal level adjusting apparatus as claimed in claim 12, farther comprising a light emitting element, wherein the clamping unit is coupled to drive the light emitting element and, the light emitting element is an organic light emitting display, a light emitting diode display, an OLED, or an LED.

14. The signal level adjusting apparatus as claimed in claim 12, wherein the clamping unit comprises a clamping element coupled to the reference voltage source, and the peak levels of the output signals are determined according to the reference voltage signal.

15. The signal level adjusting apparatus as claimed in claim 14, wherein the clamping element is a transistor or a diode.

16. The signal level adjusting apparatus as claimed in claim 15, wherein the reference voltage source comprises two resistors coupled in series to a voltage source for providing a division voltage as the reference voltage signal.

17. The signal level adjusting apparatus as claimed in claim 16, wherein the transistor is a first BJT having a base for receiving the reference voltage signal, and an emitter for outputting the output signals.

18. The signal level adjusting apparatus as claimed in claim 17, farther comprising a power amplifier circuit with one end grounded and the other end coupled to the emitter of the first BJT, for amplifying the power of the output signals.

19. The signal level adjusting apparatus as claimed in claim 18, wherein the power amplifier circuit comprises an impedance unit and a second BJT, the second BJT having an emitter grounded through the impedance unit, a base coupled to the collector of the first BJT, and a collector coupled to the emitter of the first BJT.

20. The signal level adjusting apparatus as claimed in claim 14, wherein the clamping unit further comprises a power amplifier unit for receiving the reference voltage signal, amplifying the power of the reference voltage signal and then outputting the amplified signal to the clamping element.

21. The signal level adjusting apparatus as claimed in claim 20, wherein the power amplifier unit is an amplifier having a positive end for receiving the reference voltage signal, and a negative end and an output end coupled to the clamping element.

22. The signal level adjusting apparatus as claimed in claim 21, wherein the clamping element is a diode.
